(19) United States
(12) Patent Application Publication
(10) Pub. No.: US 2024/0325808 A1
(43) Pub. Date: Oct. 3, 2024

(54) FIRE SUPPRESSION SYSTEM WITH ADVANCED DIAGNOSTICS

(71) Applicant: Tyco Fire Products LP, Cranston, RI (US)

(72) Inventors: Jeffrey R. Timler, Peshtigo, WI (US); Raymond Yoder, Marinette, WI (US); Luke Giwojna, Coleman, WI (US)

(73) Assignee: Tyco Fire Products LP, Cranston, RI (US)

(21) Appl. No.: 18/294,128

(22) PCT Filed: Aug. 13, 2022
(86) PCT No.: PCT/IB2022/057582

§ 371 Date: Jan. 31, 2024

Related U.S. Application Data
(60) Provisional application No. 63/233,549, filed on Aug. 16, 2021.

(51) Int. Cl. A62C 37/40; A62C 31/02; A62C 35/02

(52) U.S. Cl. CPC A62C 37/40; A62C 31/02; A62C 35/02

(57) ABSTRACT

A fire suppression system includes a container of fire suppressant, a nozzle positioned to direct the fire suppressant from the container towards a hazard, and an actuator configured to cause the fire suppressant to pass from the container to the nozzle. The system also includes a user interface, a controller coupled to the actuator and the user interface, a first sensor coupled to the controller and configured to provide first data indicating the presence of a fire, and a second sensor coupled to the controller and configured to provide second data indicating an internal characteristic of the controller. The controller is configured to identify an event base on the first or second data, control the actuator if the event is a fire, control the user interface to provide a notification if the event is a fault, and record second data to a storage device.

### CROSS-REFERENCE TO RELATED PATENT APPLICATION

This application claims the benefit of and priority to U.S. Provisional Application No. 63/233,549, filed Aug. 16, 2021, the entire disclosure of which is hereby incorporated by reference herein.

### BACKGROUND

The present disclosure relates generally to fire suppression systems. More specifically, the present disclosure relates to diagnostics for fire suppression systems.

### SUMMARY

At least one embodiment relates to a fire suppression system. The fire suppression system includes a container of fire suppressant, a nozzle positioned to direct the fire suppressant from the container to toward a hazard, an actuator configured to cause the fire suppressant to pass from the container to nozzle, a user interface, a controller operatively coupled to the actuator and the user interface, a first sensor operatively coupled to the controller and configured to provide first data indicating the presence of a fire, and a second sensor operatively coupled to the controller and configured to provide second data indicating an internal characteristic of the controller. The controller is configured to identify, based on the first or second data an event, and in response to the event indicating the presence of a fire, control the actuator to deliver the fire suppressant from the container to the nozzle, and in response to the event indicating a fault within the fire suppression system, control the user interface to provide a notification to a user in response to the first data indicating a fault within the fire suppression system. The controller is further configured to record the second data in a storage device.

Another embodiment relates to a method of operating a fire suppression system. The method includes receiving, at a controller comprising one or more processors, first data indicating the presence of a fire from a first sensor and receiving, at the controller, second data indicating an internal characteristic of the controller from the second sensor. The method includes identifying, by the controller, an event based on at least one of the first or second data, and controlling, by the controller, and in response to the event indicating the presence of a fire, controlling an actuator to cause fire suppressant to pass from a container and exit a nozzle towards a hazard, and in response to the event indicating a fault of the fire suppression system, controlling a user interface operatively coupled to the controller to provide a notification to a user. The method also includes recording, to a storage device, the second data.

Another embodiment relates to controller for a fire suppression system comprising processing circuitry. The controller is configured to receive first data indicating a first characteristic of the fire suppression system external to the controller, and receive second data indicating a second characteristic of the fire suppression system internal to the controller. The controller is further configured to, in response to the first data indicating the presence of a fire, control an actuator to deliver fire suppressant from a container to a nozzle directed towards a hazard, and in response to the first data indicating a fault within the fire suppression system, control a user interface to provide a notification to a user. The controller is further configured to record, to a storage device, the second data.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a fire suppression system, according to an exemplary embodiment.

FIG. 2 is a block diagram of a controller for the fire suppression system of FIG. 1, according to an exemplary embodiment.

FIG. 3 is a block diagram of a method for operating a fire suppression system, according to an exemplary embodiment.

FIG. 4 is an example of a text-based event log produced by the controller of FIG. 2, according to an exemplary embodiment.

FIGS. 5-8 are tables containing data received by the controller of FIG. 2, according to an exemplary embodiment.

FIGS. 9-11 are graphs illustrating data received by the controller of FIG. 2, according to an exemplary embodiment.

FIG. 12 is a schematic illustration of a fire suppression system, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a fire suppression system includes a controller that manages the operation of the fire suppression system. The controller receives sensor data from fire detection sensors. In response to receiving an indication from the fire detection sensors that a fire is present, the controller controls one or more actuators to trigger dispensing of fire suppressant to address the fire. The controller may further include other sensors that provide additional sensor data indicating various characteristics of the system. The controller may utilize these sensors to identify one or more fault conditions indicating failure or undesirable operation of the system.

Throughout operation, the controller logs various events, such as detecting a fire, trigging a release of fire suppressant, or identifying a fault condition. The event log may be viewed by a user to identify which events have occurred and when the events occurred. While such an event log provides a useful summary of the system operation, the event log may not provide enough information to effectively troubleshoot problems within the system.

To address this deficiency, the controller prepares a separate set of data for transmission to an external device, such as a smartphone, tablet, or computer. The exported data includes a record of all of the operation data available to the controller and is recorded at regular intervals over a period of time. Using the external device, a user may analyze the exported data to facilitate troubleshooting maintenance issues. The exported data may provide insights that would not otherwise be available using only the event log. Accordingly, this additional exported data facilitates quickly and easily identifying the causes of issues within the system, reducing system downtime and the amount of resources necessary to troubleshoot the system (e.g., maintenance personnel man hours).

### System Overview

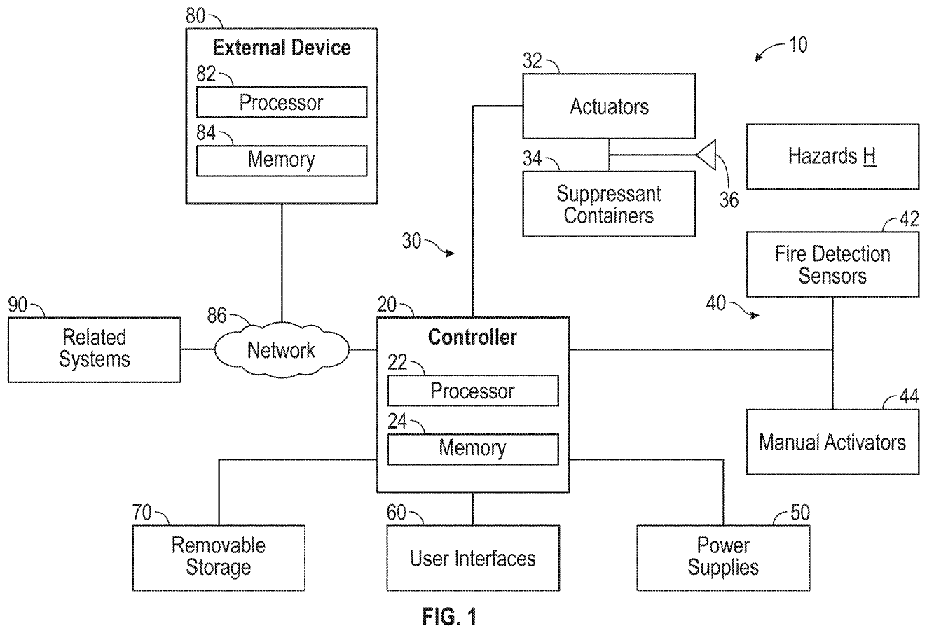

Referring to FIG. 1, a fire suppression system, fire extinguishing system, or fire management system is shown as system 10 according to an exemplary embodiment. The system 10 may be configured to identify the presence of a fire (e.g., through the use of one or more sensors). Once a fire has been identified (e.g., through the sensors or a manual actuation of the system 10 by a user), the system 10 directs fire suppressant (e.g., water, a chemical agent, etc.) toward the fire to suppress (e.g., reduce the intensity of, extinguish, prevent from restarting, etc.) the fire. The system 10 may direct the fire suppressant to only a small area identified as being nearby the fire or may blanket or flood a larger area with suppressant.

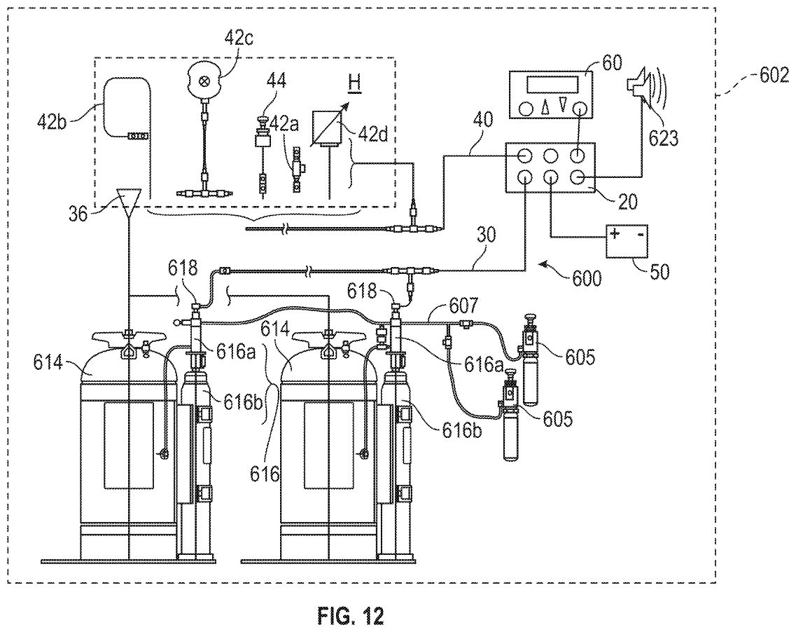

The system 10 may be utilized in a variety of different environments or applications. In some embodiments, the system 10 is used onboard a vehicle (e.g., a mining vehicle, construction equipment, logging equipment, etc.), such as shown in the configuration of FIG. 12. In other embodiments, the system 10 is used within one or more rooms of a building (e.g., in a kitchen, a workshop, an aircraft hangar, a museum, a data center, etc.). In yet other embodiments, the system 10 is used throughout (e.g., within, atop, nearby, etc.) another type of structure (e.g., a facility that processes and/or store petroleum products, etc.).

The system 10 includes processing circuitry, shown as controller 20, that controls operation of the system 10. The controller 20 includes a processor 22 and a memory device, shown as memory 24. The memory 24 may contain one or more instructions that, when executed by the processor, cause the controller 20 to execute one or more of the processes described herein. The controller 20 may be configured to (e.g., structured to) receive one or more inputs (e.g., data, commands, etc.) from and/or provide one or more outputs (e.g., data, commands, etc.) to other components of the system 10.

The system 10 includes a fire suppression or output circuit or system, shown as release circuit 30, that is operatively (e.g., communicably) coupled to the controller 20. The release circuit 30 is configured to control the release of fire suppressant by the system 10. As shown, the release circuit 30 includes one or more activators, actuators, or flow control devices, shown as actuators 32. Each actuator 32 is coupled (e.g., fluidly coupled, operatively coupled, etc.) to one or more supplies of fire suppressant or containers of fire suppressant (e.g., vessels, tanks, canisters, vats, etc.), shown as suppressant containers 34. When activated, the actuators 32 are configured to initiate a flow of the fire suppressant from the corresponding suppressant containers 34 to one or more outlets or flow shaping devices, shown as nozzles 36. The nozzles 36 may be fluidly coupled to suppressant containers 34 by one or more conduits (e.g., pipes, hoses, etc.), manifolds, flow control devices (e.g., valves), or other devices. The nozzles 36 may be positioned to direct the fire suppressant toward one or more items, shown as hazards H.

The suppressant containers 34 may contain a type of fire suppressant that is selected based upon the type of hazard H that will be protected by the system 10. In some embodiments, the fire suppressant is water. By way of example, the suppressant container 34 may be a tank of water, a well, or a municipal water supply. In some embodiments, the fire suppressant is a fire suppressant agent. By way of example, the fire suppressant may be liquid agent, a dry chemical agent, a foam agent, or another type of agent. In some embodiments, the fire suppressant is a gas (e.g., an inert gas, etc.). In some embodiments, the system 10 is configured to sequentially provide two or more different types of fire suppressant from the same nozzle 36 or set of nozzles 36. By way of example, the system 10 may initially supply a fire suppressant agent to extinguish flames affecting a hazard H and subsequently supply water to cool the hazard H and prevent reignition of the fire.

In some embodiments, the fire suppressant is stored the suppressant containers 34 under pressure. By way of example, an expellant gas may be added to the suppressant container 34. In such embodiments, the actuator 32 may be a flow control device, such as a valve. The valve may be opened to release the fire suppressant from the corresponding suppressant container 34, initiating the flow of the fire suppressant toward the nozzles 36. In some embodiments, the fire suppressant is stored a relatively low pressure (e.g., at atmospheric pressure). In such embodiments, expellant gas may be stored in a separate container (e.g., an expellant gas cartridge). The actuator 32 may be configured to selectively fluidly couple the expellant gas container to the suppressant container 34 such that the expellant gas passes into the suppressant container 34 and forces the fire suppressant toward the nozzles 36. By way of example, the actuator 32 may be a valve. By way of another example, the actuator 32 may include a puncturing device (e.g., a needle or pin) that is configured to rupture a seal of the expellant gas cartridge.

The system 10 includes a fire detection or input circuit or system, shown as detection circuit 40, operatively (e.g., communicably) coupled to the controller 20. The detection circuit 40 is configured to indicate the presence of a fire (e.g., whether or not a fire is present or is likely to be present). The detection circuit 40 may provide additional information, such as a location of the fire or a condition of the fire (e.g., a temperature of the fire, a size of the fire, etc.). In response to receiving a fire detection signal through the detection circuit 40, the controller 20 may be configured to control one or more of the actuators 32 to release the fire suppressant from the nozzles 36.

In some embodiments, the detection circuit 40 operatively couples one or more sensors, shown as fire detection sensors 42, to the controller 20. The fire detection sensors 42 may provide sensor data indicating the presence or absence of a fire. By way of example, the fire detection sensors 42 may include spot thermal detectors configured to provide an indication of a temperature of the surrounding air. The controller 20 may determine that a fire is present when a spot thermal detector indicates that the surrounding air exceeds a predetermined threshold temperature. By way of another example, the fire detection sensors 42 may include linear detection wire including two wires that are separated by an insulating material with a predetermined threshold melting temperature. When the threshold melting temperature is exceeded, the wires are brought into contact with one another, providing an electrical signal to the controller 20 indicating the presence of a fire. By way of another example, the fire detection sensors may include optical sensors. Such optical sensors may differentiate between open flames and hydrocarbon signatures. By way of another example, the fire detection sensors 42 may include linear pressure detectors that monitor the pressure of a volume of a gas (e.g., air) that increases with the surrounding temperature. The controller 20 may determine that a fire is present in response to the pressure of the gas exceeding a predetermined threshold pressure. In other embodiments, the fire detection sensors 42 include other types of sensors.

In some embodiments, the detection circuit 40 operatively couples one or more pull stations, manual interfaces, manual indicators, or manual activators, shown as manual activators 44, to the controller 20. The manual activators 44 are configured to provide an interface through which a user can manually trigger an actuation of the system 10. Specifically, the manual activators 44 permit a user to manually indicate the presence of a fire. The manual activators 44 may include buttons, levers, switches, knobs, or other input devices configured to receive an input from a user.

In some embodiments, the system 10 includes one or more electrical energy supplies or storage devices, shown as power supplies 50, electrically coupled to the controller 20. The power supplies 50 are configured to supply electrical energy to power the controller 20 and/or other devices within the system 10 (e.g., the actuators 32, the fire detection sensors 42, etc.). In some embodiments, the power supplies 50 include energy storage devices, such as batteries or capacitors. In some embodiments, the power supplies include connections to a power grid, generators (e.g., an alternator coupled to an engine of a vehicle, an electric motor operating as a generator to provide a braking force), solar panels, and/or other types of energy sources. The power supplies 50 may provide direct current electrical energy and/or alternating current electrical energy.

In some embodiments, the system 10 includes one or more input devices, output devices, or interfaces, shown as user interfaces 60, that are operatively coupled to the controller 20. The user interfaces 60 may facilitate operator control over the system 10. The user interfaces 60 may be configured to receive information provided by a user (e.g., commands, selections, data, etc.) and provide the information to the controller 20. By way of example, a user interface 60 may be configured to receive a user selection of an operating mode for the system 10 (e.g., a recording mode in which sensor data is recorded to a storage device, a maintenance mode in which the actuators 32 are disabled, a standard operating mode, etc.). Additionally or alternatively, the user interfaces 60 may be configured to provide information (e.g., system statuses, sensor measurements, etc.) from the controller 20 in a format that can be consumed by a user (e.g., visually, audibly, etc.). By way of example, a user interface 60 may indicate a current operating mode of the system 10, the date and time at which a discharge event (i.e., a dispensing of fire suppressant) occurred, an indication of a fault detected by the controller 20, etc. The user interfaces 60 may include one or more input devices, such as touchscreens, switches, knobs, dials, buttons, keyboards, mice, microphones, or other input devices. The user interfaces 60 may include one or more output devices, such as displays, lights, speakers, haptic feedback devices, or other output devices.

In some embodiments, the system 10 includes one or more memory devices or physical media, shown as removable storage 70. The removable storage 70 may be operatively coupled to the controller 20. In some embodiments, the removable storage 70 is removably coupled to the controller 20. By way of example, the controller 20 may define a port or interface that can be selectively coupled to the removable storage 70. In one such embodiment, the controller 20 defines a universal serial bus (USB) port, and the removable storage is a flash drive including a corresponding USB interface. The removable storage 70 may be configured to store data for transportation to other devices (e.g., the external device 80). Accordingly, the removable storage 70 may be removably coupled to other devices. The controller 20 may provide the data to the removable storage 70 and/or provide commands to the removable storage 70, causing the removable storage 70 to record or erase data.

In some embodiments, the system 10 is operatively coupled to one or more external devices, shown as external device 80. As shown in FIG. 1, the external device 80 includes a processor 82 and a memory device, shown as memory 84. The memory 84 may contain one or more instructions that, when executed by the processor 82, cause the external device 80 to execute one or more of the processes described herein. The external device 80 may be configured to receive data from the system 10. The external device 80 may store the data, analyze the data, provide notifications to a user based on the data (e.g., based on the analysis of the data), and/or provide commands to the controller 20 based on the data. In some embodiments, the external device 80 is a user device, such as a smartphone, a tablet, a laptop computer, or a desktop computer. In other embodiments, the external device 80 is a server. The external device 80 may include one or more user interfaces to facilitate user interaction with the external device 80.

In some embodiments, the external device 80 is configured to communicate with the controller 20. In some such embodiments, the external device 80 is configured to communicate with the controller 20 over a network 86. The network 86 may facilitate communication of data from the external device 80 to the controller 20 and/or communication of data from the controller 20 to the external device 80. The network 86 may be a local area network or a wide area network (e.g., the Internet). In other embodiments, the external device 80 communicates directly with the controller 20. The external device 80 and the controller 20 may communicate over a wired connection (e.g., Ethernet, fiber optics, etc.) or may communicate wirelessly over a wireless connection (e.g., Wi-Fi, Bluetooth, Zigbee, a cellular network, etc.).

In other embodiments, the external device 80 and the controller 20 are isolated from one another (e.g., the external device 80 and/or the controller 20 are configured as air-gapped computers). In such embodiments, the removable storage 70 may transfer data between the controller 20 and the external device. By way of example, the removable storage 70 may be operably coupled to the controller 20, and the controller 20 may command the removable storage 70 to record a set of sensor data. The removable storage 70 may be disconnected from the controller 20 and subsequently connected to the external device 80. The external device 80 may then read the sensor data from the removable storage 70.

In some embodiments, the system 10 is configured to communicate with one or more related systems 90. Specifically, the controller 20 may be configured to communicate with the related systems 90 (e.g., directly, over a network such as the network 86, etc.). The related systems 90 may have functions that are related to the operation of the system 10, and the related systems 90 may provide information (e.g., sensor data) regarding operation of these functions to the controller 20.

By way of example, if the system 10 is installed on a vehicle, the related system 90 may be a control system for the vehicle. The related system 90 may communicate information to the controller 20 regarding operation of the vehicle, such as vehicle speed, engine speed, engine temperature, fuel levels, or other vehicle-specific information. The controller 20 may communicate with the vehicle control system over a controller area network (CAN) bus.

By way of another example, if the system 10 is installed within a building (e.g., within a kitchen of a building), the related system 90 may be a building control system for the building. The related system 90 may communicate information to the controller 20 regarding the operation and/or status of the building, such as building temperatures, air flow rates, the operation status of various ventilation devices, or other building-specific information.

### Controller Configuration

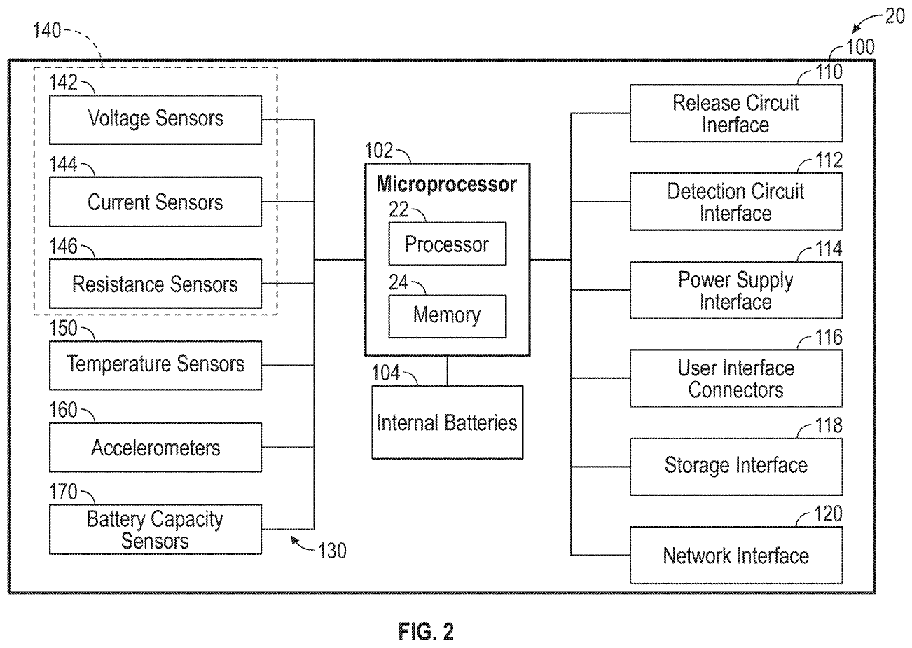

Referring to FIG. 2, the controller 20 is shown according to an exemplary embodiment. In this embodiment, the controller 20 includes a base, chassis, or substrate, shown as printed circuit board (PCB) 100, that supports the various components and circuitry of the controller 20. The PCB 100 may include various electrical components that facilitate the connections and functionality described herein. In some embodiments, the PCB 100 is contained within and/or supported by a housing. Although the controller 20 is shown as having a single PCB 100 that supports and connects the various components of the controller 20, in other embodiments, the controller 20 is split across multiple PCBs 100. As shown, the processor 22 and the memory 24 are implemented as a microprocessor 102 coupled to (e.g., mounted on) the PCB 100. In other embodiments, the processor 22 and the memory 24 are otherwise configured.

In some embodiments, the controller 20 includes one or more energy storage devices (e.g., batteries, capacitors, etc.), shown as internal batteries 104. The internal batteries 104 may be coupled to the PCB 100. In some embodiments, the internal batteries 104 are configured to power one or more functions of the controller 20. By way of example, the internal batteries 104 may provide a continuous power source regardless of whether or not the controller 20 is connected to the power supplies 50. The inclusion of the internal batteries 104 may be useful for certain continuous functions of the controller 20, such as operating an internal clock. In some embodiments, the internal batteries 104 are charged by the power supplies 50.

As shown in FIG. 2, the controller 20 includes several interfaces that facilitate communication between the controller 20 (e.g., the microprocessor 102 of the controller 20) and the other components of the system 10. The interfaces may include circuitry that facilitates the transfer of power and/or data. The interfaces may be built into and/or mounted to the PCB 100. In some embodiments, the interfaces are coupled to or include one or more of the sensors described herein (e.g., the controller sensors 130).

The controller 20 includes a release circuit interface 110 that is operatively coupled to the release circuit 30. The release circuit interface 110 facilitates communication between the controller 20 and the actuators 32. The controller 20 further includes a detection circuit interface 112 that is operatively coupled to the detection circuit 40. The detection circuit interface 112 facilitates communication between the controller 20 and the detection circuit 40. The controller 20 further includes a power supply interface 114 that is operatively coupled to the power supplies 50. The power supply interface 114 is configured to facilitate power transmission (e.g., the transfer of electrical energy) between the power supplies 50 and the controller 20. The controller 20 further includes one or more user interface connectors 116 operatively coupled to the user interfaces 60. The user interface connectors 116 facilitate communication between the user interfaces 60 and the controller 20. The controller 20 further includes a storage interface 118 operatively coupled to the removable storage 70. The storage interface 118 facilitates communication between the controller 20 and the removable storage 70. In some embodiments, the storage interface 118 includes a USB port. The controller 20 further includes a network interface 120 that is operatively coupled to the external device 80, the network 86, and/or the related systems 90. The network interface 120 facilitates communication between the controller 20 and the external device 80, the network 86, and/or the related systems 90. The network interface 120 may include Ethernet adapters, Wi-Fi adapters, Bluetooth adapters, and/or other types of communication interfaces.

Referring still to FIG. 2, the controller 20 may include one or more sensors (e.g., sensors internal to the controller 20), shown as controller sensors 130, that provide sensor data characterizing operation of the system 10. The controller sensors 130 may measure phenomena that are internal and/or external to the controller 20. The controller sensors 130 may be analog sensors and/or digital sensors. Each of the controller sensors 130 is operatively coupled to the microprocessor 102 such that the sensor data can be processed by the processor 22 and/or stored in the memory 24. The controller 20 may use the sensor data directly or may mathematically transform the data to a different format (e.g., from a resistance of the sensor to a corresponding characteristic, such as temperature).

As shown, the controller 20 includes one or more electrical sensors 140, shown as voltage sensors 142, current sensors 144, and resistance sensors 146, that are operatively coupled to the microprocessor 102. The electrical sensors 140 are configured to measure one or more electrical characteristics of the system 10 (e.g., properties of electrical energy within the system 10). Specifically, the voltage sensors 142 are configured to provide sensor data indicating a voltage of the system 10. The current sensors 144 are configured to provide sensor data indicating an electrical current of the system 10. The resistance sensors 146 are configured to provide sensor data indicating a resistance of the system 10. In some embodiments, the controller 20 utilizes the sensor data directly. By way of example, the controller 20 may utilize a voltage sensor 142 to measure a voltage at a specific point within the PCB 100. In other embodiments, the controller 20 mathematically determines an electrical characteristic utilizing sensor data relating to other electrical characteristics. By way of example, the controller 20 may utilize a current sensor 144 and a resistance sensor 146 to measure a current and a resistance, respectively, at a specific point within the PCB 100 and use the sensor data to mathematically determine the voltage at that point.

In some embodiments, the electrical sensors 140 measure a voltage of a charge pump circuit (e.g., a DC to DC converter) within the PCB 100. In some embodiments, the electrical sensors 140 measure a voltage of one or more capacitors within the PCB 100. In some embodiments, the electrical sensors 140 measure a voltage of a rail (e.g., a power supply node) within the PCB 100. In some embodiments, the electrical sensors 140 measure an electrical characteristic of electrical energy in communication with one of the related systems 90 (e.g., voltage supplied by the related systems 90). The measured electrical characteristic may indicate a status of the related system 90 (e.g., a sensor reading of the related system 90, a mode of operation of the related system 90, etc.). In some embodiments, the electrical sensors 140 measure a voltage of the internal batteries 104 and/or a voltage of the power supplies 50. In some embodiments, the electrical sensors 140 measure the current supplied by the internal batteries 104 and/or the power supplies 50.

As shown in FIG. 2, the controller 20 includes one or more thermal energy sensors, shown as temperature sensors 150, that are operatively coupled to the microprocessor 102. The temperature sensors 150 are configured to measure a temperature within the system 10 (e.g., a temperature of a component of the system 10). By way of example, the temperature sensors 150 may measure a temperature of the PCB 100.

As shown in FIG. 2, the controller 20 includes one or more movement sensors (e.g., gyroscopes, accelerometers, velocity sensors, etc.), shown as accelerometers 160, that are operatively coupled to the microprocessor 102. The movement sensors are configured to provide sensor data characterizing the movement of a portion of the system 10. Specifically, the accelerometers 160 may measure an acceleration (e.g., magnitude and/or direction) of a component of the system 10, such as the controller 20.

As shown in FIG. 2, the controller 20 includes one or more battery capacity sensors 170 that are operatively coupled to the microprocessor 102. The battery capacity sensors 170 are configured to measure a capacity (e.g., a current charge level, a total amount of electrical energy that the device is capable of providing before it is depleted) of an energy storage device. By way of example, the battery capacity sensors 170 may measure a voltage and/or current supplied by the energy storage device over time and provide an estimated battery capacity. The battery capacity sensors 170 may measure the battery capacity of the power supplies 50 and/or the internal batteries 104.

### Method of Operation

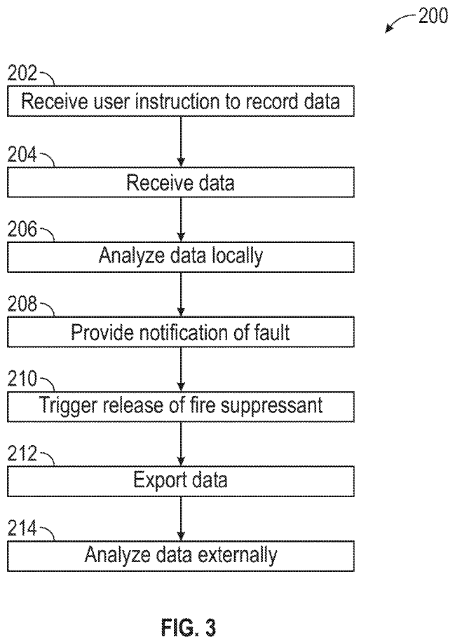

Referring to FIG. 3, a method of operating the system 10 is shown as method 200 according to an exemplary embodiment. The method 200 may be performed by the system 10 after the initial installation and commissioning of the system 10. Control logic to facilitate the method 200 may be stored in the memory 24 of the controller 20 such that the controller 20 manages performance of the method 200. Although the method 200 is shown including steps in a particular sequence, the steps of the method 200 may be omitted, reordered, and/or repeated throughout operation of the system 10.

In step 202 of the method 200, a user instruction to record data is received. Specifically, the user instruction may indicate that the user wishes for data to be recorded. A user may provide the user instruction through one or more of the user interfaces 60. The user interfaces 60 may include a switch or graphical user interface element that, when interacted with by a user, enters the controller 20 into a data recording, troubleshooting, or maintenance mode. The user may decide that data should be recorded when troubleshooting the system 10. By way of example, when troubleshooting a fault of the system 10, maintenance personnel may decide that additional data may facilitate diagnosis of the fault. In response to such a determination, the maintenance personnel may configure the controller 20 into the diagnostic mode by interacting with a user interface 60. Step 202 is optional and may not occur. By way of example, a user may not provide an instruction to record data, and the method 200 may proceed without recording data for exporting to the external device 80.

In step 204 of the method 200, the controller 20 receives data. The controller 20 may receive data from the fire detection sensors 42, the manual activators 44, the user interfaces 60, the removable storage 70, the external device 80, the related systems 90, the controller sensors 130, and/or other components of the system 10. The received data may also include information regarding commands sent by the controller 20. The controller 20 may store the received data (e.g., temporarily) in the memory 24. If the controller 20 is in the diagnostic mode, the controller 20 may cause some or all of the received data be displayed to a user through one or more of the user interfaces 60. The received data may be updated in real time such that the most recent received data is displayed.

In step 206 of the method 200, the controller 20 analyzes the received data locally. Specifically, the controller 20 may utilize the processor 22 and/or the memory 24 to analyze the received data. In some embodiments, the controller 20 is configured to analyze the received data to identify one or more fault conditions. A fault condition may indicate that a portion of the system 10 is malfunctioning and requires maintenance. The criteria for identifying a fault condition may be predetermined and stored in the memory 24. The controller 20 may compare the received data to the criteria to determine if a fault condition is present. By way of example, the controller 20 may monitor one or more circuits for shorts or open circuit conditions and identify a fault condition if a short or open circuit condition is present. By way of another example, the controller 20 may monitor the output of a sensor and identify a fault condition if the output of the sensor is outside of predetermined range corresponding to normal operation. In one such example, the system 10 is provided on a vehicle, and the controller 20 monitors the output of an accelerometer 160 and indicates a fault condition in response to the accelerometer 160 measuring an acceleration that the vehicle is incapable of reaching under engine power.

In some embodiments, the controller 20 is configured to analyze the received data to identify the presence of a fire. By way of example, the controller 20 may identify the presence of a fire in response to a user interacting with one of the manual activators 44. By way of another example, the controller 20 may analyze the sensor data provided by the fire detection sensors 42. In some such examples, the controller 20 compares the sensor data to predetermined thresholds. By way of example, the controller 20 may determine that a fire is present in response to a temperature sensor measuring a temperature that exceeds a predetermined threshold temperature. By way of another example, the controller 20 may determine that a fire is present in response to an optical sensor identifying light of greater than a predetermined threshold intensity.

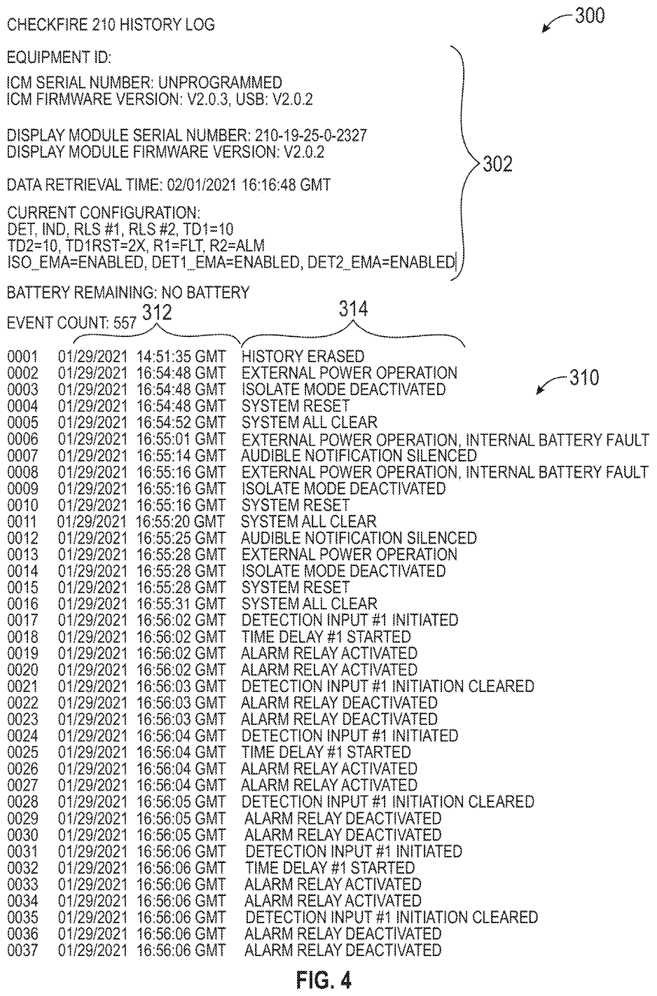

The controller 20 may record one or more identified events (e.g., fault conditions, fire detections, alarms, commands issued by the controller 20, inputs received from a user, etc.) in one or more event logs. FIG. 4 illustrates an event log 300 generated by the controller 20 according to an exemplary embodiment. The controller 20 may generate the event log 300 throughout operation based on the analysis of the received data. The controller 20 may display the event log 300 on a user interface 60. The controller 20 may transfer the event log 300 to the removable storage 70 and/or the external device 80 for review by a user.

As shown, the event log 300 includes identification information 302 that identifies the system 10. The identification information 302 can include serial numbers, software and firmware versions, information identifying the type and quantity of devices within the system 10, and/or other information. The event log 300 further includes a series of event listings 310, each event listing 310 logging an event identified by the controller 20. As shown, each event listing 310 includes a date/time stamp 312 that identifies a time and date when the event occurred and a description 314 describing the event.

In response to the controller 20 identifying a fault condition or an event, the method 200 may proceed to step 208, in which a notification of the fault (i.e., event) is provided. Specifically, the controller 20 may provide a notification (e.g., an audible alarm, a text notification on a display, a flashing light, etc.) to a user indicating that a fault condition or an identified event has been identified. The controller 20 may control one or more of the user interfaces 60 to provide the notification. Additionally or alternatively, the controller 20 may control the external device 80 to provide the notification.

In response to the controller 20 identifying the presence of a fire, the method 200 may proceed to step 210, in which the controller 20 triggers a release or distribution of fire suppressant. The controller 20 may trigger the release by providing an activation signal to one or more of the actuators 32. In response to receiving the activation signal, the actuators 32 may release the fire suppressant from the corresponding suppressant containers 34, permitting the fire suppressant to pass out of the nozzles 36 to address the fire affecting the hazards H. In some embodiments, the controller 20 provides the activation signal to all of the actuators 32 such that all of the fire suppressant is released at one time. In other embodiments, the controller 20 provides the activation signal to a subset of the actuators 32 corresponding to an area where the fire is located.

Prior to and/or during the distribution of the fire suppressant, the controller 20 may activate one or more alarms. By way of example, the controller 20 may utilize the user interfaces 60 and/or the related systems 90 to provide one or more alarms to alert a user to the presence of a fire. The alarms may be auditory (e.g., sirens, bells, etc.) and/or visual (e.g., flashing lights).

In step 212 of the method 200, the controller 20 exports the received data. The controller 20 may store the received data at multiple points in time (e.g., each with a corresponding time stamp), such that the exported data illustrates the changes in the received data over time. The range of time corresponding to the exported data and/or the frequency with which the data are recorded may be specified by the user (e.g., by providing an input to a user interface 60 in step 202). By way of example, a user may specify a time range over which the user wishes the data to be recorded (e.g., from a first date/time to a second date/time, storing a rolling 20 minute set of data that continuously updates until the data is exported, etc.). By way of another example, the user may specify that the data is updated and recorded once per second. Additionally or alternatively, the controller 20 may automatically record data surrounding (e.g., before and/or after) one or more events. By way of example, when a fault condition is identified, the controller 20 may record data from the 20 minutes prior to the fault condition and for 20 minutes after the fault condition for exporting.

In some embodiments, the controller 20 is configured to export the received data by saving the received data to the removable storage 70. A user may then disconnect the removable storage 70 from the controller 20 and connect the removable storage 70 to the external device 80. The external device 80 may transfer the exported data from the removable storage 70 to the memory 84.

In some embodiments, the controller 20 is configured to export the received data over the network 86 to the external device 80 or directly to the external device 80. A user may initiate a transfer of the exported data from the controller 20 to the external device 80 by interacting with a user interface 60 of the controller 20 or a user interface of the external device 80. By way of example, the user may initiate a transfer of the exported data by interacting with a graphical user interface of the user interface 60. By way of another example, the user may initiate a transfer of the exported data by interacting with a user interface of the external device 80. Prior to initiating a transfer of exported data, the controller 20 may require a form of identification (e.g., a password, a biometric input, etc.) in order to verify that the user has permission to initiate the transfer.

In some embodiments, the controller 20 is configured to encrypt the exported data prior to transferring the exported data for security purposes. By way of example, the exported data may be converted to an encrypted form (e.g., an encrypted text file) using an encryption algorithm. In the encrypted form, the exported data may be unreadable. The exported data may be transferred over the network 86 and/or stored on the removable storage 70 in the encrypted form. The external device 80 may utilize a corresponding decryption algorithm to decrypt the exported data into a decrypted form that can be read by the external device 80.

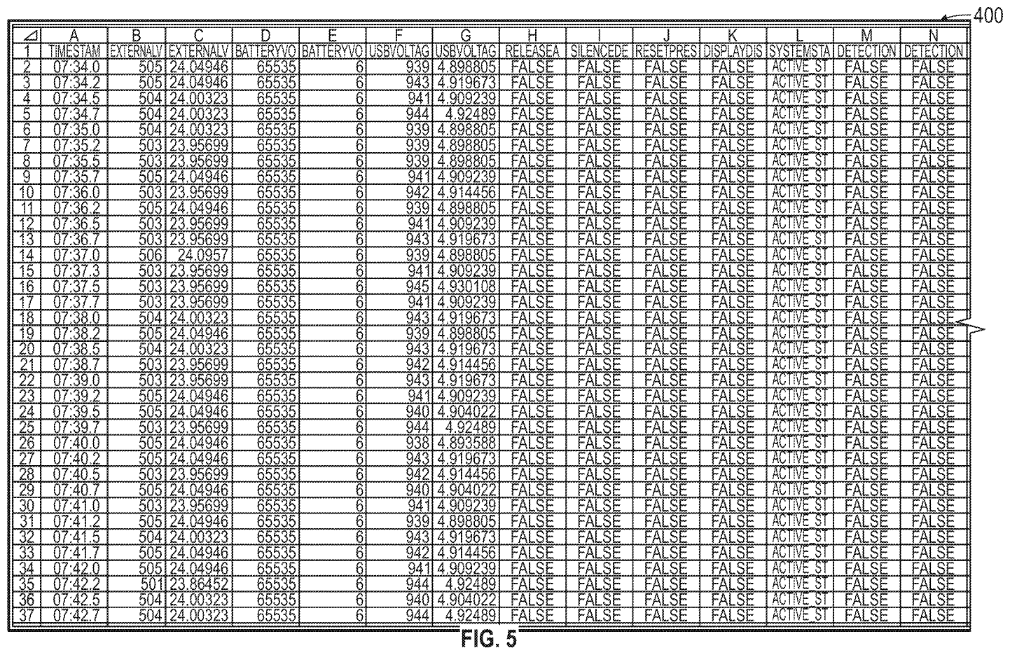

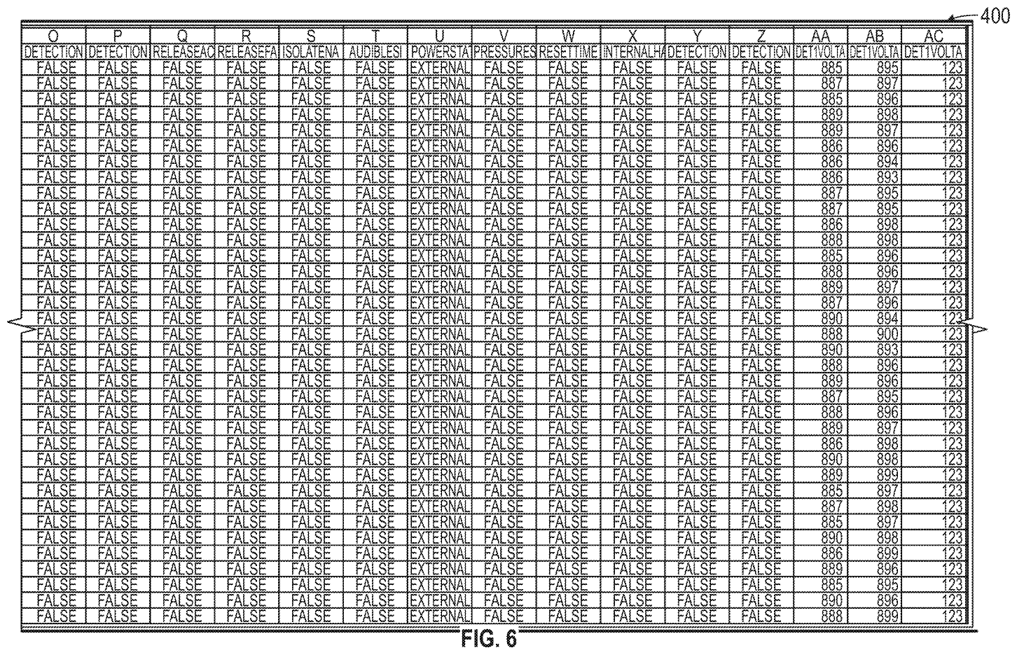

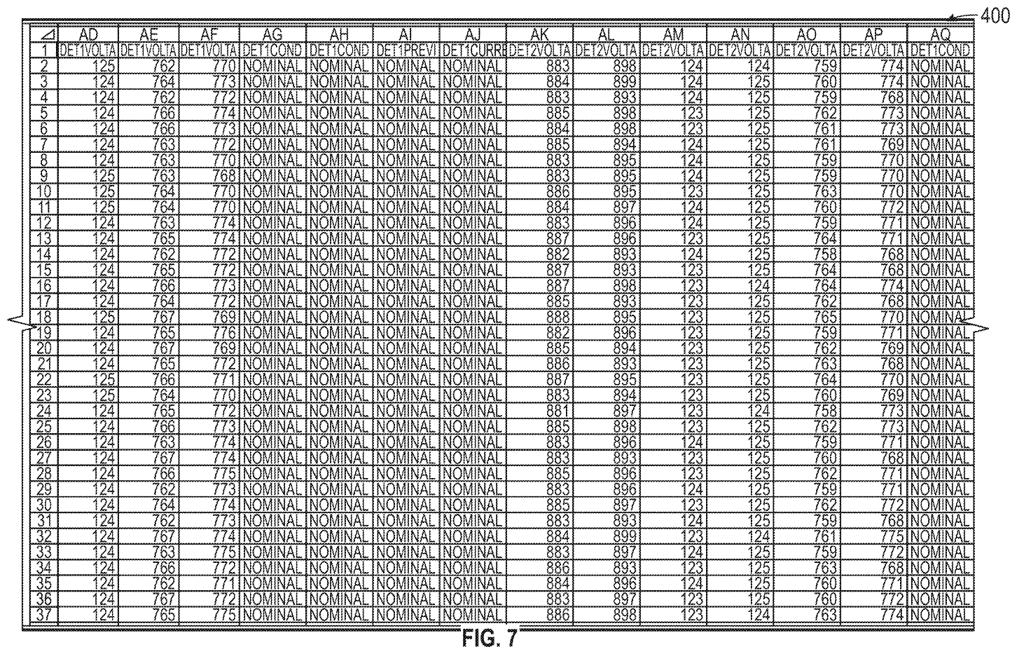

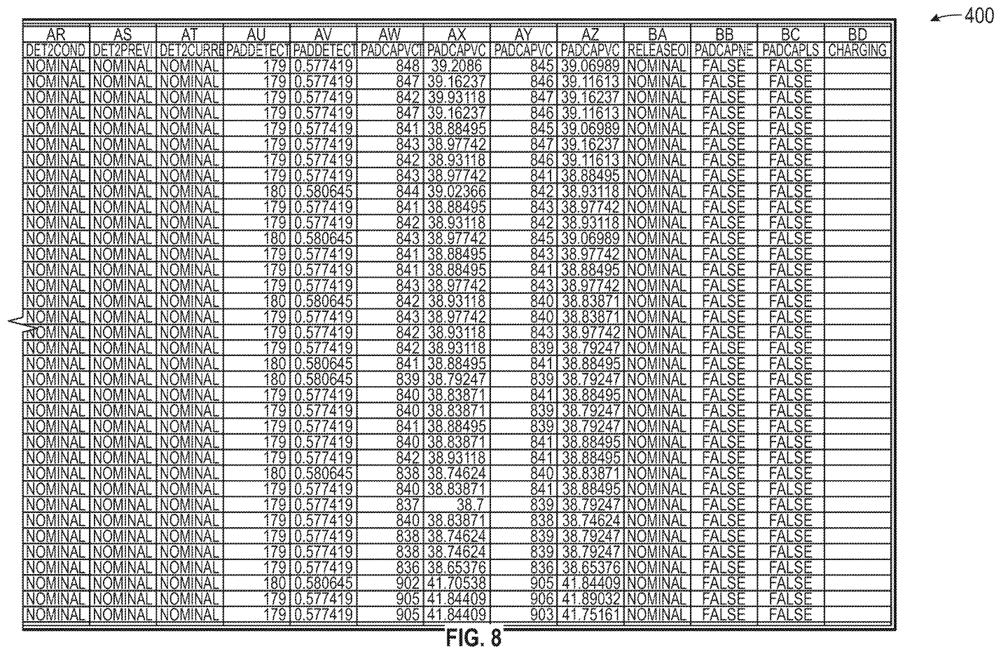

FIGS. 5-8 illustrate a sample set of the exported data 400 (e.g., prior to encryption by the controller 20, after decryption by the external device 80, etc.). As shown, the exported data 400 is arranged in a table or spreadsheet that extends across each of FIGS. 5-8 (i.e., the table is divided amongst FIGS. 5-8 for ease of viewing). Each row of the table represents a series of different measurements or statuses corresponding to a given time and/or date. As shown, each row is provided with a timestamp that indicates both the date and the time associated with the measurements, and measurements are taken every 0.25 seconds. In other embodiments, the timestamp indicates the passage of time relative to a particular event (e.g., the elapsed time since startup of the controller 20). In other embodiments, the measurements are taken at a different sample rate or frequency (e.g., once every 0.1 second, once every second, once every 10 seconds, etc.). Each column of the table represents a type of measurement or status (e.g., a measured voltage, whether or not a condition is detected, etc.). As shown, the exported data includes all of the raw data available to the controller 20 regarding the system 10. In some embodiments, the controller 20 does not filter or otherwise modify the exported data such that the external device 80 can access all of the same data as the controller 20 once the exported data is transferred and decrypted.

In step 214 of the method 200, the exported data is analyzed. The exported data may provide additional context to facilitate a more in-depth and thorough analysis than simply reviewing the event log 300. For example, the event log 300 may be used to identify an event of interest to the user, such as a fault condition or a release of fire suppressant. The exported data in temporal proximity to the event of interest (e.g., soon before or soon after) may be evaluated or analyzed to identify trends that may have caused the event. By accessing all of the data available to the controller 20, a wide variety of different factors may be investigated. This may facilitate identifying the cause of the event (e.g., a failing component) more quickly, reducing maintenance downtime.

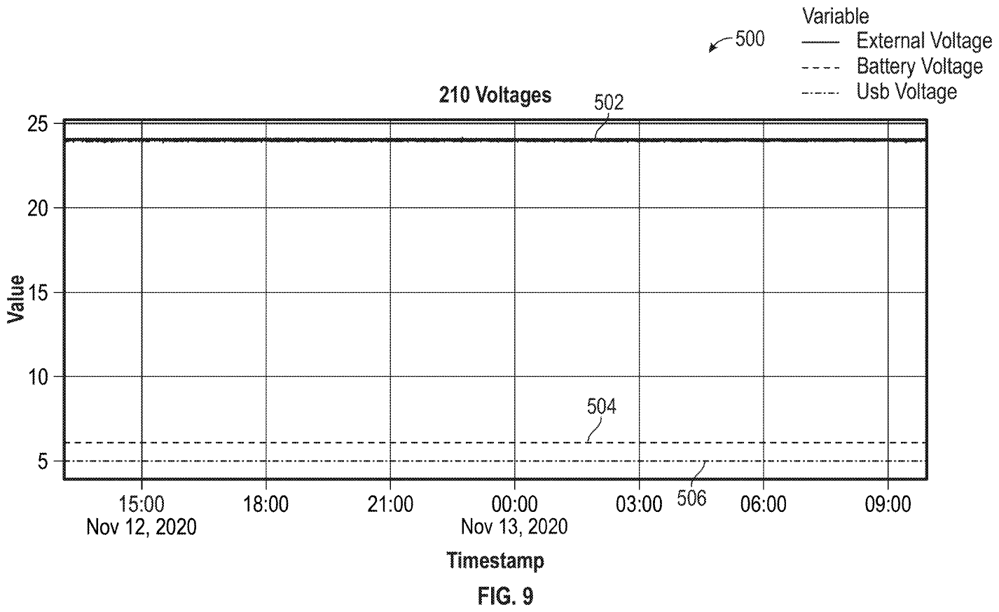

FIGS. 9-11 illustrate a subset of the exported data, according to an exemplary embodiment. In this example, the exported data was recorded during a test, during which the controller 20 was subjected to a high pressure and high temperature spray of water containing a cement dissolving detergent for an extended period of time (e.g., approximately 20 hours). Midway through the test, a connector of the detection circuit 40 (e.g., a connector connected to the detection circuit interface 112) was opened to ensure water ingress into the connector for testing purposes.

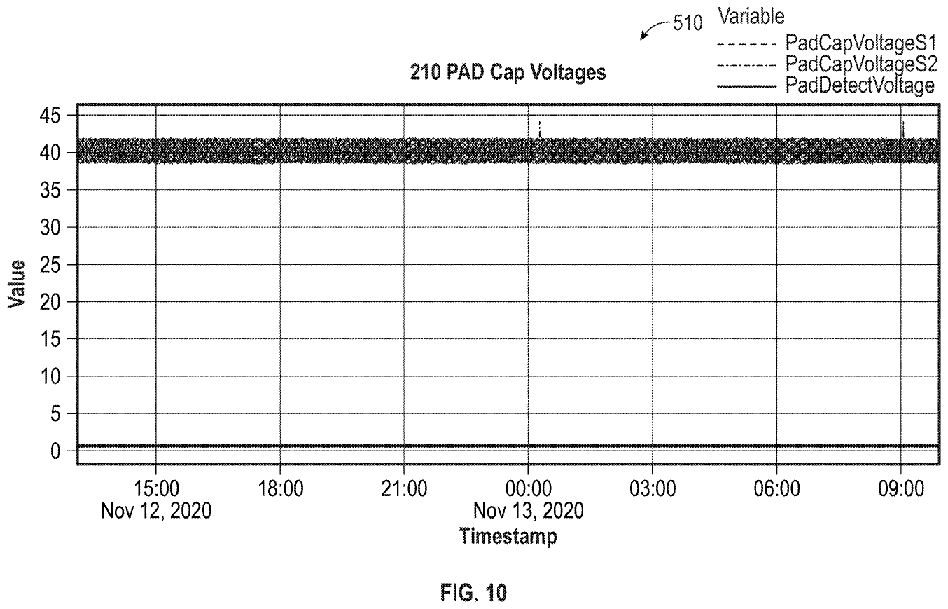

FIG. 9 includes a graph 500 illustrating sensor data representing various measured voltages throughout the test. Specifically, a line 502 represents the voltage supplied by a power supply 50, a line 504 represents the voltage supplied by an internal battery 104, and a line 506 represents the voltage supplied by a USB power supply within the controller 20. As shown, the line 502, the line 504, and the line 506 were substantially constant throughout the test. FIG. 10 includes a graph 510 illustrating the voltages of various capacitors throughout the release circuit 30. Specifically, lines 512, 514, and 516 each illustrate the voltages of different capacitors. As shown, each of the lines 512, 514, and 516 were substantially constant throughout the test or fluctuated throughout a regular range throughout the test.

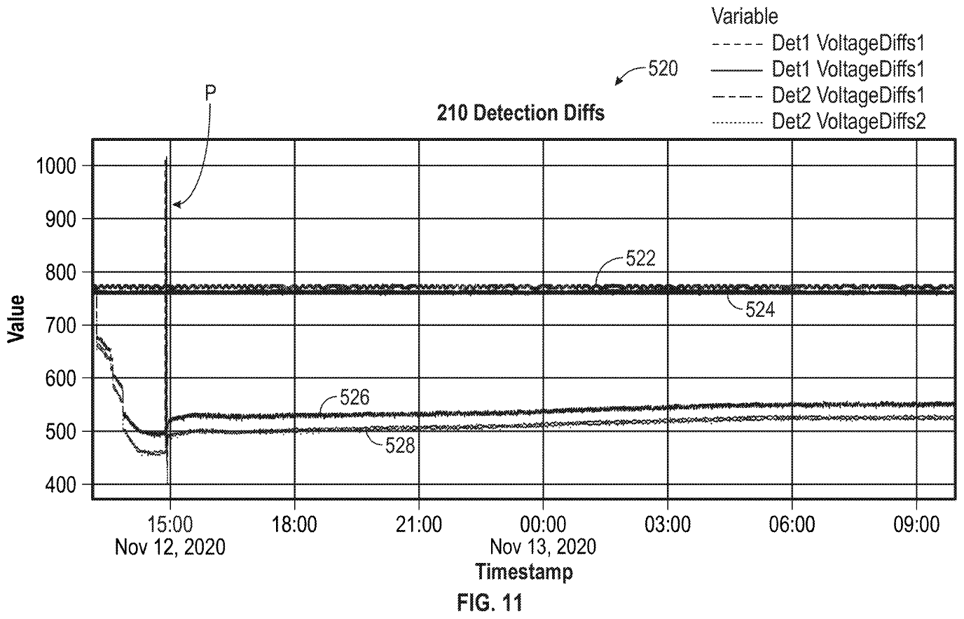

FIG. 11 includes a graph 520 illustrating various resistances throughout the detection circuit 40. Specifically, lines 522 and 524 illustrate the resistances at two locations within the detection circuit 40 that would be expected during normal operation. Lines 526 and 528 illustrate the measured resistances at those two locations. As shown, the resistances represented by the lines 526 and 528 were expected to be substantially constant. Instead, the resistance gradually decreased due to the ingress of fluid into the connector. The resistance sharply increased to a peak P when the connector was opened (i.e., the sharp increase in resistance represents an open circuit). After the connector was again closed, the resistances settled at values well below the expected resistances of lines 522 and 524.

During this testing, the controller 20 reported only one event of interest. Specifically, the controller 20 reported that the detection circuit 40 experienced an open circuit condition when the connector of the detection circuit 40 was opened (e.g., due to detection by the controller 20 of the peak P). However, the event log 300 would not have provided any further information regarding the testing. Accordingly, if a user were to review only the event log 300, the user would know only that the connector had been opened.

By reviewing the exported data shown in FIG. 11 in addition to the event log 300, it becomes clear that fluid was able to penetrate the connector, causing the resistance of the circuit to drop significantly. Accordingly, a user would be able to quickly and easily identify the connector as a potential point of failure. If the resistance had continued to drop (e.g., due to continued fluid ingress), the resistance would have fallen below a threshold resistance indicative of the presence of a fire. Accordingly, the fluid ingress could have triggered an errant actuation of the system 10, dispensing fire suppressant when a fire was not present. Again, reviewing solely the event log 300 would have only provided a notification of when the erroneous detection of fire took place and when the suppressant was released. Analysis of the exported data provides additional context that could be used to quickly and easily identify the connector as the source of the error. This reduces system downtime and the required maintenance resources for the system 10, reducing cost and increasing performance.

The analysis of the exported data in step 214 may be performed by the external device 80 and/or a user. In some embodiments, the external device 80 displays the exported data (e.g., as a table, as one or more graphs, etc.). The external device 80 may permit user selection of which of the exported data is displayed. The user may review the displayed data to identify data that is relevant to the current troubleshooting operation.

In some embodiments, the external device 80 is configured to identify a subset of the exported data that may be relevant to the user. The external device 80 may then highlight the relevant subset of the exported data for review by a user (e.g., by creating tables or graphs with only the relevant subset of the exported data, by making the relevant subset visually identifiable using colors, etc.). In some such embodiments, the external device 80 utilizes the event log 300 to identify the relevant subset of the exported data. By way of example, each event that the event log 300 is capable of identifying may be associated with a predetermined subset of the exported data. In one such example, an identification of the presence of a fire by the detection circuit 40 may be associated with electrical characteristics (e.g., resistance) of the detection circuit 40, such that the external device 80 highlights data indicating the electrical characteristics of the detection circuit 40 in response to the detection circuit 40 identifying the presence of a fire. In other embodiments, the external device 80 may compare the exported data to predetermined thresholds, ranges, or patterns that are associated with normal operation of the system 10. In response to a subset of the exported data failing to conform with the predetermined thresholds, ranges, or patterns, the external device may highlight the subset of the exported data as being relevant to the user.

### Exemplary System Configuration

Referring to FIG. 12, a suppression system 600 as shown as a configuration of the system 10, according to an exemplary embodiment. The system 600 may be substantially similar to the system 10, except as otherwise specified herein. The system 600 is included within a vehicle 602 (e.g., a mining vehicle, a logging vehicle, etc.). Accordingly, the system 600 may be configured to address one or more fires onboard the vehicle 602.

In some embodiments, the system 600 includes a fire suppressant agent supply coupled to a nozzle 36 (e.g., a fixed nozzle) to protect a hazard H or area in which an ignition source and fuel or flammable materials may be found. As shown, the fire suppressant agent supply may include one or more storage tanks or cylinders 614 (e.g., suppressant containers 34) containing the fire suppressant, such as for example a chemical agent. Each storage tank 614 has a corresponding a pressurized cylinder assembly 616 containing expellant gas. The pressurized cylinder assemblies 616 are configured to provide the expellant gas to pressurize the cylinders 614 for delivery of the fire suppressant agent under an operating pressure to the nozzle 36 to address a fire affecting the hazard H. In some embodiments, the pressurized cylinder assembly 616 includes a rupturing device 616a (e.g., an actuator 32) which punctures a rupture disc of a pressurized cylinder 616b containing a pressurized expellant gas, such as for example nitrogen, to pressurize the storage tank 614 for delivery of the fire suppressant agent.

In order to operate the rupturing device 616a, the system 600 may provide for automatic actuation and manual operation of the rupturing device 616a to provide for respective automated and manual delivery of the chemical agent in response a fire for protection of the hazard H. The rupturing or actuating device 616a or assembly 616 may include a puncturing pin or member that is driven into the rupture disc of the pressurized cylinder 616b for release of the pressurized gas. The puncturing pin of the rupturing device 616a may be driven electrically or pneumatically to puncture the rupture disc of the pressurized cylinder 616b.

One or more manual activators, shown as manual activation cartridges 605, may be used to manually actuate the rupturing devices 616a. Each manual activation cartridge 605 includes a volume of compressed gas and an interface (e.g., a button). When the interface is activated, the compressed gas is released into a conduit, shown as hose 607. The hose 607 is fluidly coupled to each of the rupturing devices 616a. The hose 607 directs the compressed gas to a chamber of each of the rupturing devices 616a such that the compressed gas forces the puncturing pin downward to puncture the rupture disc of the pressurized cylinder 608.

The controller 20 may provide one or more electrical signals to automatically actuate the actuating device 616a. The actuating device 616a may include a protracted actuation device (PAD) 618 for driving the puncturing pin of the assembly into the rupture disc. The PAD 618 includes an electrically coupled rod or member that is disposed above the puncturing pin. When an electrical signal is delivered to the PAD 618 (e.g., from the controller 20), the rod of the PAD 618 is driven directly or indirectly into the puncturing pin, which punctures the rupture disc of the pressurized cylinder 616b.

In some embodiments, the controller 20 is operatively coupled to an audio alarm or speaker 623. The speaker 623 may an auditory alarm indicating the status of the system 600. In some embodiments, the speaker 623 is incorporated into the user interface 60.

As shown, the fire detection sensors 42 can include analog and digital devices for various modes for fire detection including: (i) spot thermal detectors 42a to determine when the surrounding air exceeds a set temperature, (ii) linear detection wire 42b which conveys a detection signal from two wires that are brought into contact upon a separating insulation material melting in the presence of a fire, (iii) optical sensors 42c which differentiate between open flames and hydrocarbon signatures, and (iv) a linear pressure detector 42d in which pressure of an air line increases in the presence of sufficient temperature. The manual activator 44 is shown as a manual push button which sends an actuating signal to the controller 20.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various exemplary embodiments is illustrative only. Additionally, any element disclosed in one embodiment may be incorporated or utilized with any other embodiment disclosed herein. For example, the speaker 623 of the exemplary embodiment shown in at least FIG. 12 may be incorporated in the system 10 of the exemplary embodiment shown in at least FIG. 1. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A fire suppression system, comprising:
a container of fire suppressant;
a nozzle positioned to direct the fire suppressant from the container to toward a hazard;
an actuator configured to cause the fire suppressant to pass from the container to nozzle;
a user interface;
a controller operatively coupled to the actuator and the user interface;
a first sensor operatively coupled to the controller and configured to provide first data indicating the presence of a fire;
a second sensor operatively coupled to the controller and configured to provide second data indicating an internal characteristic of the controller, wherein the controller is configured to;
identify, based on at least one of the first data or the second data, an event;
in response to the event indicating the presence of a fire, control the actuator to deliver the fire suppressant from the container to the nozzle;
in response to the event indicating a fault within the fire suppression system, control the user interface to provide a notification to a user; and
record the second data on a storage device.

2. The fire suppression system of claim 1, wherein the second data comprises measurements from multiple points in time.

3. The fire suppression system of claim 1, wherein the controller is further configured to:
identify a subset of the second data associated with the event; and
record the subset of the second data on the storage device.

4. The fire suppression system of claim 3, wherein the second data comprises measurements from multiple points in time, and wherein the subset of the second data comprises measurements for a predetermined amount of time before the event.

5. The fire suppression system of claim 1, wherein the event is identified based on at least one of the first data or the second data meeting a predetermined criteria corresponding to the event.

6. The fire suppression system of claim 1, wherein the controller is further configured to:
transmit, via a network, the second data to an external device.

7. The fire suppression system of claim 6, wherein the controller is further configured to transmit the second data in real-time.

8. The fire suppression system of claim 1, wherein the internal characteristic of the controller includes at least one of an electrical characteristic, a temperature, an acceleration, or a battery capacity.

9. The fire suppression system of claim 1, wherein the controller is further configured to identify a cause of the event based on the second data.

10. A method of operating a fire suppression system comprising:
receiving, at a controller comprising one or more processors, first data indicating the presence of a fire from a first sensor;
receiving, at the controller, second data indicating an internal characteristic of the controller from a second sensor;
identifying, by the controller, an event based on at least one of the first data or the second data;
in response to the event indicating the presence of a fire, controlling an actuator to cause fire suppressant to pass from a container and exit a nozzle towards a hazard; in response to the event indicating a fault within the fire suppression system, controlling a user interface operatively coupled to the controller to provide a notification to a user; and
recording, to a storage device, the second data.

11. The method of claim 10, wherein the second data comprises measurements from multiple points in time.

12. The method of claim 10, further comprising:
identifying, by the controller, a subset of the second data associated with the event; and
recording, to the storage device, the subset of the second data.

13. The method of claim 12, wherein the second data comprises measurements from multiple points in time for a predetermined amount of time prior to the event.

14. The method of claim 10, wherein the event is identified based on at least one of the first data or the second data meeting a predetermined criteria corresponding to the event.

15. The method of claim 10, wherein the internal characteristic of the controller is at least one of an electrical characteristic, a temperature, an acceleration, or a battery capacity.

16. The method of claim 10, further comprising identifying, based on the second data, a cause of the event.

17. A controller for a fire suppression system comprising processing circuitry configured to:
receive first data indicating a first characteristic of the fire suppression system external to the controller;
receive second data indicating a second characteristic of the fire suppression system within the controller;
in response to the first data indicating the presence of a fire, control an actuator to deliver fire suppressant from a container to a nozzle directed towards a hazard;
in response to the first data indicating a fault within the fire suppression system, control a user interface to provide a notification to a user; and
record, to a storage device, the second data.

18. The controller of claim 17, wherein the second characteristic is at least one of a voltage, a current, a resistance, a battery capacity, a temperature, or an acceleration of the controller.

19. The controller of claim 17, wherein the controller is further configured to transmit, via a network, the second data to an external device.

20. The controller of claim 17, wherein the second data comprises measurements from multiple points in time for a predetermined time period based on the first data.
